(19) United States
(12) Patent Application Publication
(10) Pub. No.: US 2026/0184729 A1
(43) Pub. Date: Jul. 2, 2026

(54) DEPOLYMERIZATION OF SILICONE TO OBTAIN ORGANOCHLOROSILANE

(71) Applicants: ELKEM SILICONES FRANCE SAS, LYON (FR); UNIVERSITÉ CLAUDE BERNARD LYON 1, VILLEURBANNE (FR); CENTRE NATIONAL DE LA RECHERCHE SCIENTIFIQUE, PARIS (FR); ECOLE SUP CHIMIE PHYS ELECTRONIQ LYON (CPE LYON), VILLEURBANNE (FR)

(72) Inventors: Aurelie BOULEGUE MONDIERE, MILLERY (FR); Nicolas DURAND, TERNAY (FR); Duc-Nam VU, LYON (FR); Jean RAYNAUD, VILLEURBANNE (FR); Vincent MONTEIL, LYON (FR)

(21) Appl. No.: 18/867,227

(22) PCT Filed: May 17, 2023
(86) PCT No.: PCT/EP2023/063230

§ 371 Date: Nov. 19, 2024

(30) Foreign Application Priority Data
May 19, 2022 (FR) FR2204800

(51) Int. Cl. C07F 7/08

(52) U.S. Cl. CPC C07F 7/0874

(57) ABSTRACT

A method is described for preparing organochorosilane CS by reacting at least one silicone S with a metal chloride or metalloid CM in the presence of at least one metal salt catalyst SM, wherein the metal chloride or metalloid CM is different from the metal salt SM.

The present invention generally relates to the reuse of silicone polymers. More specifically, the process of the present invention relates to the depolymerization of silicone polymers to obtain organochlorosilanes. This process advantageously allows the recycling of used or unused silicone polymers for the preparation of organochlorosilanes which may then be used in polymerization reactions.

The recycling of industrial products and used silicone products is a current issue. Silicone recycling could reduce gas emissions (CO, CO₂) from the silicone industry by 75%, and silicone waste by 65%.

The depolymerization of organopolysiloxanes to fluorosilane is already known and described. Its reactions are thermodynamically favorable since Si—F bonds are very strong (about 135 kcal/mol) relative to the Si—O bonds of organopolysiloxanes (about 110 kcal/mol). However, these methods have certain drawbacks, notably the release of volatile products and the cost of fluorine sources.

Si—Cl bonds, on the other hand, are weaker (notably 90 kcal/mol), so depolymerizing organopolysiloxanes to organochlorosilane is not favorable.

Enthaler et al. (J. Appl. Polym. Sci. 2015) have disclosed the depolymerization of polydimethylsiloxanes to produce chlorosilanes. The catalyst used is an iron salt. However, this process requires a large amount of catalyst (7.5% by weight of catalyst relative to the weight of organopolysiloxane), a corrosive chlorine source of the acyl chloride type and a high temperature of about 170-190° C.

It would thus be advantageous to provide an alternative process for depolymerizing silicones into organochlorosilane. There is notably an interest in providing a catalytic system that allows this depolymerization to be performed at lower temperatures, allowing the amount of catalyst used to be limited, and allowing other chloride sources to be used.

One object of the present patent application is thus to propose a process for depolymerizing silicones in an efficient manner and affording a good yield of organochlorosilane.

Another object of the present patent application is to provide a catalytic system for performing this process.

Yet another object of the present patent application is to propose a simple, non-hazardous catalytic system that is compatible with industrialization of the process.

Other objects will also be seen on reading the following description of the invention.

These objects are fulfilled by the present patent application, which relates to a process for preparing organochlorosilane CS by reacting at least one silicone S with a metal or metalloid chloride MC in the presence of at least one metal salt catalyst MS, the metal or metalloid chloride MC being different from the metal salt MS.

Silicones, otherwise known as organopolysiloxanes, are polymer materials comprising silicon and oxygen atoms alternating with various silicon-bonded organic radicals.

In the context of the present invention, the term “silicone” or “silicone product” or “silicone polymer” or “organopolysiloxane” means polymers comprising a siloxane (Si—O—Si) backbone containing silicon and oxygen atoms alternating with various silicon-bonded organic radicals. These silicone polymers may be liquid or solid, depending on the molecular weight and the degree of crosslinking.

The silicones S of the invention may be of any type, for example linear organopolysiloxanes O such as oils or gums, or branched organopolysiloxanes O such as resins.

The organopolysiloxane O may notably be an oil or a gum, and preferably has a dynamic viscosity of between 50 and 600 000 mPa·s at 25° C. or a consistency of between 200 and 2000 expressed in tenths of a millimeter at 25° C. All the viscosities referred to herein correspond to a dynamic viscosity value at 25° C. known as “Newtonian”, i.e. the dynamic viscosity which is measured, in a manner known per se, with a Brookfield viscometer at a sufficiently low shear rate gradient for the measured viscosity to be independent of the rate gradient.

The term “gum” is used for organopolysiloxane compounds with viscosities conventionally greater than 600 000 mPa·s, which corresponds to a molecular weight of greater than 260 000 g/mol.

These organopolysiloxanes O may comprise one or more functional units such as:
OH;
H;
alkenyl notably comprising from 2 to 6 carbon atoms, preferably vinyl;
O-Alk with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl;
(O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200;
a linear or branched alkyl group comprising from 1 to 10 carbon atoms, preferably from 1 to 5 carbon atoms, substituted with at least one fluorine atom, for example from 1 to 10 fluorine atoms, for example (C1-C5)alkyl-CF₃, the alkyl being linear or branched;
amine group, notably (Alk)-NH₂ or (Alk)-NH-(Alk)-NH₂, with Alk representing an alkyl comprising from 1 to 5 carbon atoms;
cyclic amine for example —(CH₂)_{z}—O-piperidine in which z represents an integer from 1 to 5, preferably 3, and the piperidine may be substituted notably with one or more alkyl groups comprising from 1 to 3 carbon atoms, preferably methyl; preferably, the substituted piperidine is a group

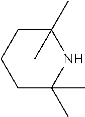

Preferably, the functional units are chosen from:
OH;
H;
alkenyl notably comprising from 2 to 6 carbon atoms, preferably vinyl;
a linear or branched alkyl group comprising from 1 to 10 carbon atoms, preferably from 1 to 5 carbon atoms, substituted with at least one fluorine atom, for example from 1 to 10 fluorine atoms, for example (C1-C5)alkyl-CF₃, the alkyl being linear or branched.

Preferably, the organopolysiloxanes O may comprise one or more functional units such as H, OH, alkenyl (preferably vinyl), aryl or cyclic amine, as defined above.

The organopolysiloxanes O of the invention may be partially crosslinked.

The organopolysiloxanes O of the invention may notably be spent organopolysiloxanes which have been used, for example, as heat transfer fluids and which it would be advisable to recycle, the process of the invention thus making it possible to generate organochlorosilanes which can then be used directly in industrial processes. In the case where spent organopolysiloxanes O are used, the organopolysiloxane may thus contain other elements such as additives, pigments, etc. The inventors have shown that the presence of these other elements does not interfere with the depolymerization reaction and the formation of organochlorosilane CS.

According to one embodiment of the invention, the organopolysiloxane O of the invention comprises:
at least 5, preferably at least 10, siloxyl units of formula R_{c}SiO_{(4-C)/2} in which
R, which may be identical or different, represents
   an alkyl group comprising from 1 to 15 carbon atoms, preferably from 1 to 12 carbon atoms, preferably from 1 to 10 carbon atoms, preferably from 1 to 5 carbon atoms, preferably methyl;
   an aryl group comprising from 6 to 10 carbon atoms, preferably phenyl;
and c=0, 1, 2 or 3; and
optionally one or more units of formula R¹_{d}RₑSiO_{(4-d-e)/2} in which:
R is as defined above
R¹, which may be identical or different, represents:
   an alkenyl group comprising from 2 to 6 carbon atoms, preferably vinyl;
   hydroxyl group (OH);
   a group (O-Alk) with Alk representing an alkyl group comprising from 1 to 15 carbon atoms, preferably from 1 to 12 carbon atoms, preferably from 1 to 10 carbon atoms, preferably from 1 to 5 carbon atoms, preferably OCH₃ or OC₂H₅,
   a group (O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
   a linear or branched alkyl group comprising from 1 to 10 carbon atoms, preferably from 1 to 5 carbon atoms, substituted with at least one fluorine atom, for example from 1 to 10 fluorine atoms, for example (C1-C5)alkyl-CF₃, the alkyl being linear or branched;
   an amine group chosen from (Alk)-NH₂ and (Alk)-NH-(Alk)-NH₂, with Alk representing an alkyl comprising from 1 to 5 carbon atoms;
   cyclic amine for example —(CH₂)_{z}—O-piperidine in which z represents an integer from 1 to 5, preferably 3, and the piperidine may be substituted notably with one or more alkyl groups comprising from 1 to 3 carbon atoms, preferably methyl; preferably, the substituted piperidine is a group

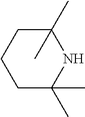

a hydrogen;
   d=1, 2 or 3, preferably d=1 or 2, more preferentially d=1; e=0, 1 or 2; and the sum d+e=1, 2 or 3.

It is understood in the above formulae that, if several groups R are present or if several groups R¹ are present, they may be identical to or different from each other.

Preferably, in the above formulae, R¹, which may be identical or different, represents:
an alkenyl group comprising from 2 to 6 carbon atoms, preferably vinyl;
a hydroxyl group (OH);
a linear or branched alkyl group comprising from 1 to 10 carbon atoms, preferably from 1 to 5 carbon atoms, substituted with at least one fluorine atom, for example from 1 to 10 fluorine atoms, for example (C1-C5)alkyl-CF₃, the alkyl being linear or branched;
a hydrogen.

In the present invention:
an “M” siloxyl unit represents a siloxyl unit of formula Y₃SiO_{1/2},
a “D” siloxyl unit represents a siloxyl unit of formula Y₂SiO_{2/2},
a “T” siloxyl unit represents a siloxyl unit of formula YSiO_{3/2},
a “Q” siloxyl unit represents a siloxyl unit of formula SiO_{4/2}, the symbols Y being R or R¹.

The organopolysiloxane O may optionally comprise T and Q units.

According to a preferential embodiment, the organopolysiloxane O of the invention is preferably chosen from the compounds of formula (I):

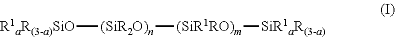

in which:
R, which may be identical or different, represents:
   an alkyl group comprising from 1 to 15 carbon atoms, preferably from 1 to 12 carbon atoms, more preferably from 1 to 10 carbon atoms, more preferably from 1 to 5 carbon atoms, more preferably methyl;
   an aryl group comprising from 6 to 10 carbon atoms, preferably phenyl;
      R¹, which may be identical or different, represents:
an alkenyl group comprising from 2 to 6 carbon atoms, preferably vinyl;
a hydroxyl group (OH);
a group (O-Alk) with Alk representing an alkyl group comprising from 1 to 15 carbon atoms, preferably from 1 to 12 carbon atoms, preferably from 1 to 10 carbon atoms, preferably from 1 to 5 carbon atoms, preferably OCH₃ or OC₂H₅,
a group (O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
a linear or branched alkyl group comprising from 1 to 10 carbon atoms, preferably from 1 to 5 carbon atoms, substituted with at least one fluorine atom, for example from 1 to 10 fluorine atoms, for example (C1-C5)alkyl-CF₃, the alkyl being linear or branched;
an amine group chosen from (Alk)-NH₂ and (Alk)-NH-(Alk)-NH₂, with Alk representing an alkyl comprising from 1 to 5 carbon atoms;
cyclic amine for example —(CH₂)_{z}—O-piperidine in which z represents an integer from 1 to 5, preferably 3, and the piperidine may be substituted notably with one or more alkyl groups comprising from 1 to 3 carbon atoms, preferably methyl; preferably, the substituted piperidine is a group

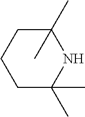

a hydrogen;
   a is an integer and represents 0, 1, 2 or 3, preferably 0, 1 or 2, more preferentially 0 or 1;
   n represents an integer between 10 and 10 000, preferably between 10 and 5000, more preferably between 50 and 5000, more preferentially between 60 and 5000, for example between 70 and 1000;
   m represents an integer between 0 and 100, preferably between 0 and 50, more preferentially between 0 and 30; preferably, m=0.

Particularly preferably, the organopolysiloxane O of the invention is a compound of formula (I)
in which R¹, which may be identical or different, represents:
   an alkenyl group comprising from 2 to 6 carbon atoms, preferably vinyl;
   a hydroxyl group (OH);
   a linear or branched alkyl group comprising from 1 to 10 carbon atoms, preferably from 1 to 5 carbon atoms, substituted with at least one fluorine atom, for example from 1 to 10 fluorine atoms, for example (C1-C5)alkyl-CF₃, the alkyl being linear or branched;
   a hydrogen.

Particularly preferably, the organopolysiloxane O of the invention is a compound of formula (I)
in which R¹, which may be identical or different, represents CH₃, vinyl, H, (C1-C5)alkyl-CF₃ or OH.

Particularly preferably, the organopolysiloxane O of the invention is a compound of formula (I)
in which:
R, which may be identical or different, represents CHs or phenyl, preferably CHs;
R¹, which may be identical or different, represents:
   an alkenyl group comprising from 2 to 6 carbon atoms, preferably vinyl;
   a hydroxyl group (OH);
   a linear or branched alkyl group comprising from 1 to 10 carbon atoms, preferably from 1 to 5 carbon atoms, substituted with at least one fluorine atom, for example from 1 to 10 fluorine atoms, for example (C1-C5)alkyl-CF₃, the alkyl being linear or branched;
   a hydrogen.

Particularly preferably, the organopolysiloxane O of the invention is a compound of formula (I)
in which:
R, which may be identical or different, represents CHs or phenyl, preferably CH₃;
R¹, which may be identical or different, represents CH₃, vinyl, H, (C1-C5)alkyl-CF₃ or OH.

The silicones S of the invention may also be crosslinked silicone materials, for instance gels or elastomers. Crosslinked silicone materials can be obtained by polycondensation, radical polymerization, thermal or UV-irradiated polyaddition, etc.

Silicone products have a multitude of applications. By way of example, they can be found in food applications (for example molds), medical applications and in the pharmaceutical sector, for instance in baby bottle teats, catheters, implants or tubes for medical applications. In technical industrial applications, silicone is often used as a material for seals or membranes. In the automotive sector, it is used for hoses, cable sheathing or insulation, and as a damping material.

Silicone elastomers are crosslinked silicone materials comprising fillers, for instance silica, to obtain good mechanical properties.

By varying the silicone oils, fillers and additives, and also the crosslinking method, silicone elastomers exhibit different properties and colors.

Silicone elastomers may be divided into three main groups that are well known to those skilled in the art. High-temperature vulcanization (HTV) or heat-cured rubber (HCR) elastomers are silicone elastomers obtained from very high-viscosity silicone compositions comprising silicone gums and fillers. They are vulcanized at high temperatures, generally between 140° C. and 200° C. The crosslinking is either radical-mediated, catalyzed with peroxides, or obtained by an addition reaction in which platinum compounds are used as catalysts.

Liquid silicone rubbers (LSR) are silicone elastomers obtained from compositions comprising silicone oils and fillers. Crosslinking occurs by an addition reaction at temperatures similar to those of EVCs, with crosslinking generally taking place much more rapidly, obtained by crosslinking two components which are mixed just before the start of crosslinking.

The third group are silicones obtained by crosslinking silicone compositions at room temperature from silicone oils and fillers crosslinked by polycondensation or polyaddition reactions. These elastomers are known under the name “room temperature vulcanization” (RTV) silicone elastomer. These compositions are available in one- and two-component systems.

In the process of the present application, the term “silicone S” also means silicone-based materials, for example materials comprising at least 0.1% by weight of silicone relative to the total weight of silicone-based material. The silicone-based material may comprise up to 100% by weight of silicone, preferably up to 99.9% by weight of silicone relative to the total weight of silicone-based material. These silicone-based materials may also comprise additives or fillers such as dyes, silica, calcium carbonate, calcium oxide, celite, quartz, titanium oxide, cerium hydroxide, magnesium oxide, mica, etc.

In the process of the invention, the metal or metalloid chlorides MC notably comprise metalloid chlorides, transition metal chlorides and alkaline-earth metal chlorides, alone or as mixtures.

Preferably, the metal or metalloid chlorides MC are chosen from metal chlorides of formula M′Clz in which
M′ represents B, Al, Ti, Zr, Mg, Zn, Ca, Sb, Ge, Si, or Cu, preferably B, Al, Ti, Zr, Mg, Ca, Zn, preferably B, Al, Mg, Zn, Ca, preferably B, Al;
z represents an integer depending on the valency of the metal M′, for example z represents 3, 4 or 5.

The metal or metalloid chlorides MC are preferably chosen from BCl₃, AlCl₃, TICl₄, ZrCl₄, MgCl₂, ZnCl₂, CuCl₂, CaCl₂, SiCl₄, GeCl₄ and SbCl₅, alone or as a mixture, preferably BCl₃, AlCl₃, MgCl₂, ZnCl₂ and CaCl₂, more preferentially AlCl₃ and BCl₃, preferably BCl₃.

The metal or metalloid chloride MC may be in solution in a solvent. This is particularly advantageous in the case of solid or gaseous metal or metalloid chlorides, so as to dissolve these chlorides in the reaction medium. The solvent may notably be an organic solvent of the alkane, haloalkane or aromatic hydrocarbon type. Preferably, the solvent is chosen from dichloromethane, n-hexane, n-heptane, toluene, xylene and mesitylene.

Preferably, the amount of metal or metalloid chloride MC used in the process of the invention is at least 50 mol %, preferably between 50 and 800 mol % relative to the number of moles of Si—O, preferably between 50 and 300 mol %, for example between 50 and 200 mol %.

In the context of the present invention, the term “number of moles of Si—O” means the number of moles of Si—O bonds in the silicone S.

In the case where the starting silicone S is of unknown formula, notably in the case of formulated commercial products, it is possible to estimate the number of moles of Si—O. Specifically, for formulated products, a person skilled in the art knows that the amount of filler is between 20% and 40% by mass, and thus, by estimating the amount of filler at an average of 30% by mass, this gives 70% by mass of silicone, enabling the number of moles of Si—O bonds to be calculated from the average molar mass of the repeating unit.

The metal salt MS used as catalyst in the process of the invention is preferably chosen from salts of elements from Group 13 of the Periodic Table and transition metals. The metal salts MS are preferably metal salts comprising at least one halogen atom, preferably Cl, Br, I, F, for example metal halides of formula MXₘ in which:
M represents Ga, Ge, Al, In or Fe, preferably Ga, Al or Fe,
X represents Cl, Br, I, F, OTf, BF₄ or SbF₆,
m represents an integer depending on the metal M, and preferably m represents 2, 3 or 4.

Preferably, the metal salt MS is chosen from GaCl₃, FeCl₂, FeCl₃, InCl₃, AlCl₃ and GeCl₄, preferably FeCl₃, FeCl₂, AlCl₃, GaCl₃ and InCl₃.

Depending on the nature of the metal salt, it is possible to dissolve it in a solvent. The solvent may notably be an organic solvent of the alkane, haloalkane or aromatic hydrocarbon type. Preferably, the solvent is chosen from dichloromethane, n-hexane, n-heptane, toluene, xylene and mesitylene.

Preferably, the amount of metal salt MS used in the process of the invention is between 0.01% and 10% by weight relative to the weight of silicone S, preferably between 0.1% and 5% by weight, for example between 0.1% and 2% by weight.

Preferably, the amount of metal salt MS used in the process of the invention is between 0.01 mol % and 10 mol % relative to the number of moles of Si—O, preferably between 0.01 mol % and 5 mol %, for example between 0.1 mol % and 2 mol %.

Preferably, the Cl/Si—O mole ratio, the amount of chlorine being that from the metal or metalloid chloride MC and the number of moles of Si—O corresponding to the number of moles of Si—O bonds in the silicone S, Is between 1 and 3, preferably between 2 and 3, for example between 2 and 2.5, for example 2.

Advantageously and preferably, the reaction is performed at a temperature of between 0 and 200° C., preferably between 0 and 150° C., more preferably between 2° and 130° C., more preferentially between 3° and 110° C.

The reaction time may be from a few minutes to a few hours.

A person skilled in the art will know how to adapt the temperature and duration of the reaction as a function of the reagents used and the reactors.

The process of the invention advantageously affords a mass yield of organochlorosilane CS of greater than 80%, preferably greater than 90%, more preferably greater than 95%.

In the context of the present invention, the term “organochlorosilane” means compounds of the following formulae (A), (B) or (C):

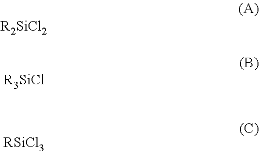

with R, which may be identical or different, chosen from:
   H,
   linear or branched alkyl comprising from 1 to 15 carbon atoms, preferably from 1 to 12 carbon atoms, preferably from 1 to 10 carbon atoms, preferably from 1 to 5 carbon atoms, preferably methyl;
   aryl comprising from 6 to 10 carbon atoms, preferably phenyl;
   OH;
   alkenyl notably comprising from 2 to 6 carbon atoms, preferably vinyl;
   a linear or branched alkyl group comprising from 1 to 10 carbon atoms, preferably from 1 to 5 carbon atoms, substituted with at least one fluorine atom, for example from 1 to 10 fluorine atoms, for example (C1-C5)alkyl-CF₃, the alkyl being linear or branched;
   O-Alk with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl;
   (O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200;
   amine group, notably (Alk)-NH₂ or (Alk)-NH-(Alk)-NH₂, with Alk representing an alkyl comprising from 1 to 5 carbon atoms;
   cyclic amine for example —(CH₂)_{z}—O-piperidine in which z represents an integer from 1 to 5, preferably 3, and the piperidine may be substituted notably with one or more alkyl groups comprising from 1 to 3 carbon atoms, preferably methyl, the substituted piperidine is a group

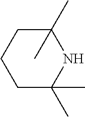

preferably, the organochlorosilanes of the invention comprise not more than one hydrogen atom.

Preferably, in formulae (A), (B) and (C), R, which may be identical or different, is chosen from:
H,
linear or branched alkyl comprising from 1 to 15 carbon atoms, preferably from 1 to 12 carbon atoms, preferably from 1 to 10 carbon atoms, preferably from 1 to 5 carbon atoms, preferably methyl;
aryl comprising from 6 to 10 carbon atoms, preferably phenyl;
OH;
alkenyl notably comprising from 2 to 6 carbon atoms, preferably vinyl;
a linear or branched alkyl group comprising from 1 to 10 carbon atoms, preferably from 1 to 5 carbon atoms, substituted with at least one fluorine atom, for example from 1 to 10 fluorine atoms, for example (C1-C5)alkyl-CF₃, the alkyl being linear or branched;
preferably, the organochlorosilanes of the invention comprise not more than one hydrogen atom.

Preferably, the preferred organochlorosilanes of the invention are those of formula (I) or (II).

Without wishing to be bound by any theory:
the organopolysiloxanes of formula (I) are derived from the D units of silicone S, the radicals R of formula (I) thus being dependent on the D units of silicone S;
the organopolysiloxanes of formula (II) are derived from the M units of silicone S, the radicals R of formula (II) thus being dependent on the M units of silicone S;
the organopolysiloxanes of formula (III) are derived from the T units of silicone S, the radicals R of formula (III) thus being dependent on the T units of silicone S.

Particularly advantageously, the organochlorosilanes obtained via the process of the invention can be used directly in other industrial processes as a source of starting materials, then hydrolyzed and condensed to manufacture novel oils, resins or gums.

The present patent application also relates to the use of the organochlorosilanes obtained via the process of the invention for the preparation of silicone, for example for the preparation of silicone oils, resins or gums.

The present patent application also relates to a process for preparing silicones, notably oils, resins or gums, comprising the following steps:
1) implementation of the organochlorosilane preparation process according to the invention;
2) preparation of silicone, notably oils and resins or gums, from the organochlorosilanes obtained in step 1).

Step 2) may notably be performed by condensing hydrolysis.

The present patent application will now be described by means of the examples that follow.

### EXAMPLES

### Silicones Used in the Examples:

In the text hereinbelow, Me=methyl, Vi=vinyl
Silicone S1:

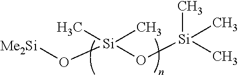

n=70 viscosity 100 mPa·s
Silicone S2:

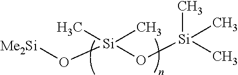

n=180, viscosity 1000 mPa·s
Silicone S3:

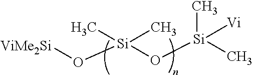

n=70; viscosity 100 mPa·s
Silicone S4:

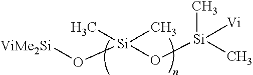

n=278, viscosity 1500 mPa·s
Silicone S5:

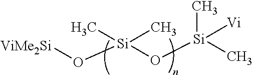

n=476, viscosity 10 000 mPa·s
Silicone S6:

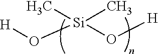

n=46, viscosity 100 mPa·s
Silicone S7:

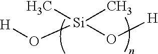

n=656, viscosity 14 000 mPa·s
Silicone S8:

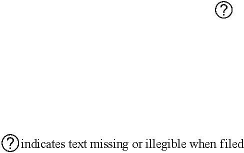

n=40-50, m=10-15
Silicone S9:

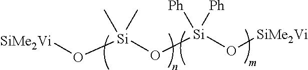

n=800-900, m=40-120, viscosity 60 000 mPa·s
Silicone S10:

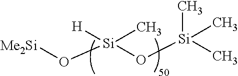

Silicone S11: silicone gum

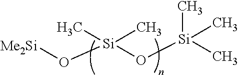

Mn 0.6 to 100×10⁶ g/mol
Silicone S12: silicone nipple pad (commercial product, composition unknown)
Silicone S13: silicone cake mold (commercial product, composition unknown)
Silicone S14: silicone sheet (commercial product, composition unknown)
Silicone S15: silicone tube (commercial product, composition unknown)
Silicone S16: EVC A
Silicone S17: EVC B
Silicone S18: RTV1
Silicone S19: RTV2
Silicone S20: Fluoro silicone oil (Mn=14 000) (CAS 63148-56-1)

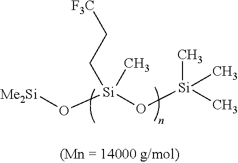

### Example 1: General Batch Protocol

A silicone S and a metal chloride MC are placed in a round-bottomed flask (10 mL). A metal salt MS or a metal salt solution is added and the reaction medium is heated (temperature 40° C.) for 30 minutes. The reaction medium is cooled to room temperature (about 25° C.) and mesitylene (240 mg) is introduced (mesitylene is an internal standard for detecting the amount of organochlorosilane in the desired products). A sample is collected and analyzed by 1H NMR and 29Si NMR. The yields in moles of compound of formula (I) and compound of formula (II) relative to the number of moles of D and M units respectively of silicone S are determined.

### Example 2: Effect of the Catalyst on the Process of the Invention

The protocol of Example 1 is performed with silicone S1 (300 mg, 4 mmol of Me₂SiO unit) and BCl₃ in 1 M dichloromethane (3 mL, 9 mmol Cl⁻, 350 mg of BCl₃) as metal chloride. The metal salt (MS), the temperature and the reaction time are indicated in Table 1 below.

| | mol % | | | | |
|---|---|---|---|---|---|
| | of | | | | |
| | MS | | | | |
| | relative | | | | |
| | to the | | | Yield of | Yield of |
| | number | | | compound | compound |
| Metal salt | of | | T | of | of |
| (amount | moles | Cl/Si-O | (° C.), | formula | formula |
| in mg) | of Si-O | ratio | time | (I) | (II) |
| | | 2 | 40° C., | 0 | 22 |
| | | | 24 h | | |
| FeCl₃ | 0.5 | 2 | 40° C., | 90 | 99 |
| (4 mg) | | | 16 h | | |
| FeCl₃ | 0.5 | 2 | 40° C., | 97 | 99 |
| (4 mg) | | | 24 h | | |
| GaCl₃ | 0.5 | 2 | 40° C., | 98 | 99 |
| (4 mg) | | | 0.5 h | | |
| AlCl₃ | 0.5 | 2 | 40° C., | 85 | 99 |
| (4 mg) | | | 0.5 h | | |
| GaCl₃ | 0.25 | 2 | 40° C., | 97 | 95 |
| (0.2 ml of | | | 2 h | | |
| a solution | | | | | |
| of GaCl₃ | | | | | |
| in dichloromethane | | | | | |
| 10 mg/ml) (2 mg) | | | | | |
| GaCl₃ | 0.05 | 2 | 40° C., | 98 | 98 |
| (0.5 ml of | | | 18 h | | |
| a solution | | | | | |
| of GaCl₃ | | | | | |
| in dichloromethane | | | | | |
| 1 mg/ml) (0.5 mg) | | | | | |
| GaCl₃ | 0.02 | 2 | 40° C., | 67 | 95 |
| (0.2 ml of | | | 24 h | | |
| a solution | | | | | |
| of GaCl₃ | | | | | |
| in dichloromethane | | | | | |
| 1 mg/ml) (0.2 mg) | | | | | |
| GaCl₃ | 0.5 | 2 | 25° C., | 70 | 99 |
| (4 mg) | | | 0.5 h | | |
| GaCl₃ | 0.5 | 2 | 0° C., | 67 | 99 |
| (4 mg) | | | 0.5 h | | |
| GaCl₃ | | 2 | 40° C., | 95 | 99 |
| (50 mol %) + | | | 0.5 h | | |
| AgBF₄ | | | | | |
| (50 mol %) | | | | | |
| GaBr₃ | 0.5 | 2 | 40° C., | 95 | 99 |
| (7 mg) | | | 0.5 h | | |
| Ga(Otf)₃ | 0.5 | 2 | 40° C., | 70 | 99 |
| (12 mg) | | | 0.5 h | | |

The process according to the invention may be performed with various metal salts while at the same time giving good yields.

### Example 3: Effect of the Chlorine Source on the Process of the Invention

The protocol of Example 1 is performed with silicone S1 (300 mg, 4 mmol of SiMe₂O unit) and GaCl₃ as metal salt (4 mg, 0.5 mol % relative to the number of moles Si—O). The metal chloride, the temperature and the reaction time are indicated in Table 2 below.

| | | | Yield of | Yield of |
|---|---|---|---|---|
| | | | compound | compound |
| Metal chloride (mL | | T | of | of |
| solution) (mg of | Cl/Si-O | (° C.), | formula | formula |
| metal chloride) | ratio | time | (I) | (II) |
| BCl₃ in | 2 | 40° C., | 98 | 99 |
| dichloromethane (1M) | | 0.5 h | | |
| (3 mL) (350 mg) | | | | |
| BCl₃ in | 1 | 40° C., | 19 | 99 |
| dichloromethane (1M) | | 0.5 h | | |
| (1.5 mL) (350 mg) | | | | |
| BCl₃ in n-heptane (1M) (3 | 2 | 40° C., | 60 | 99 |
| mL) (350 mg) | | 2 h | | |
| BCl₃ in n-heptane (1M) (3 | 2 | 40° C., | 75 | 99 |
| mL) (350 mg) | | 5 h | | |
| BCl₃ in toluene (1M) (3 mL) | 2 | 40° C., | 62 | 99 |
| (350 mg) | | 0.5 h | | |
| BCl₃ in toluene (1M) (3 mL) | 2 | 40° C., | 95 | 99 |
| (350 mg) | | 2 h | | |
| BCl₃ in toluene (1M) (3 mL) | 2 | 90° C., | 82 | 99 |
| (350 mg) | | 0.5 h | | |
| BCl₃ in toluene (1M) (3 mL) | 2 | 90° C., | 97 | 99 |
| (350 mg) | | 2 h | | |
| AlCl₃ (360 mg, | 2 | 40° C., | 12 | 99 |
| 8 mmol Cl⁻) in | | 24 h | | |
| dichloromethane (1M) (3 mL) | | | | |
| Dichloromethane or | 2 | 40° C., | 0 | 0 |
| dichloroethane (1M) (3 mL) | | 24 h | | |
| (comparative) | | | | |
| HCl in dioxane (4M) (2 mL) | 2 | 40° C., | 0 | 99 |
| (comparative) | | 24 h | | |

The process of the invention may be performed with different chlorine sources while at the same time giving good yields.

### Example 4: Effect of the Silicone on the Process of the Invention

The protocol of Example 1 is performed with various silicones indicated in Table 3 below, GaCl₃ as metal salt (0.5 mol %, 4 mg), BCl₃ as metal chloride at a concentration of 1 M in toluene or dichloromethane solvent (3 mL, except for S10:6 ml). The process is performed at 40° C. The silicone, the temperature and the reaction time are indicated in Table 3 below.

| | | Amount of BCl₃ | | Cl/Si-O | Yield of |
|---|---|---|---|---|---|
| Silicone (g) | | (mg) in solution | | ratio | compound (I) |
| S1 (0.3 | g) | (350 | mg) | 2 | 98 |
| S1 (2 | g) | (2.3 | g) | 2 | 98 |
| S2 (0.3 | g) | (350 | mg) | 2 | 97 |
| S3 (0.3 | g) | (350 | mg) | 2 | 96 |
| S4 (0.3 | g) | (350 | mg) | 2 | 95 |
| S5 (0.3 | g) | (350 | mg) | 2 | 93 |
| S6 (0.3 | g) | (350 | mg) | 2 | 97 |
| S7 (0.3 | g) | (350 | mg) | 2 | 95 |
| S8 (0.3 | g) | (350 | mg) | 2 | 90 |
| S9 (0.3 | g) | (350 | mg) | 2 | 97 |
| S10 (0.48 | g) | (700 | mg) | 2 | 94 |
| S12 (0.5 | g) | (350 | mg) | 2 | 90 |
| S13 (0.5 | g) | (350 | mg) | 2 | 96 |
| S14 (0.5 | g) | (350 | mg) | 2 | 95 |
| S15 (0.5 | g) | (350 | mg) | 2 | 95 |
| S11 (0.5 | g) | (350 | mg) | 2 | 95 |
| S16 (0.5 | g) | (350 | mg) | 2 | 99 |
| S17 (0.5 | g) | (350 | mg) | 2 | 80 |
| S18 (0.5 | g) | (350 | mg) | 2 | 95 |
| S19 (0.5 | g) | (350 | mg) | 2 | 95 |
| S12-S19 (3 g of a | | 2.1 | g | 2 | 83 |
| mixture of S12 to S19) | | | | | |
| S20 (0.65 | g) | (350 | mg) | 2 | 95 |

The results of Table 3 show that the process of the invention is versatile and can be used on all types of silicone including silicone mixtures and silicones comprising fillers or even spent silicones.

1. A method of preparing organochlorosilane CS, the method comprising reacting at least one silicone S with a metal or metalloid chloride MC in the presence of at least one metal salt catalyst MS, wherein the metal or metalloid chloride MC is different from the metal salt MS.

2. The method as claimed in claim 1, wherein the metal or metalloid chloride MC is selected from the group consisting of metalloid chlorides, transition metal chlorides, alkaline-earth metal chlorides, and mixtures thereof.

3. The method as claimed in claim 1, wherein the metal or metalloid chloride MC is a metal chloride of formula M′Cl_{z} in which
M′ represents B, Al, Ti, Zr, Mg, Zn, Ca, Sb, Ge, Si, or Cu;
z represents an integer depending on the valency of the metal M′.

4. The method as claimed in claim 1, wherein the metal or metalloid chloride MC is selected from the group consisting of BCl₃, AlCl₃, TiCl₄, ZrCl₄, MgCl₂, ZnCl₂, CuCl₂, CaCl₂, GeCl₄, SiCl₄, SbCl₅, and mixtures thereof.

5. The method as claimed in claim 1, wherein the metal salt is a compound of formula MXₘ in which:
M represents Ga, Ge, Al, In or Fe,
X represents Cl, Br, I, F, OTf, BF₄ or SbF₆,
m represents an integer depending on the metal M.

6. The method as claimed in claim 1, wherein the metal salt is selected from the group consisting of GaCl₃, FeCl₂, FeCl₃, InCl₃, AlCl₃ and GeCl₄.

7. The method as claimed in claim 1, wherein the amount of metal salt MS used in the method is from about 0.01 mol % to about 10 mol % relative to the number of moles of Si—O.

8. The method as claimed in claim 1, wherein the reaction is performed at a temperature of from about 0° C. to about 200° C.

9. The method as claimed in claim 1, wherein the Cl/Si—O mole ratio is from about 1 to about 3.

10. The method as claimed in claim 1, wherein the amount of metal or metalloid chloride MC used in the method is at least about 50 mol %.

11. A process of preparing silicones, notably silicone oils, resins or gums, the process comprising the following steps:
1) implementing the organochlorosilane preparation method as claimed in claim 1; and
2) preparing the silicone, notably silicone oil and resin or gum, from the organochlorosilanes obtained in step 1).

12. The method as claimed in claim 3, wherein M′ represents B, Al, Ti, Zr, Mg, Ca, or Zn.

13. The method as claimed in claim 3, wherein M′ represents B, Al, Mg, Zn, or Ca.

14. The method as claimed in claim 3, wherein M′ represents B, or Al.

15. The method as claimed in claim 3, wherein z represents 3, 4 or 5.

16. The method as claimed in claim 4, wherein MC is selected from the group consisting of BCl₃, AlCl₃, MgCl₂, ZnCl₂ and CaCl₂.

17. The method as claimed in claim 4, wherein MC is AlCl₃ or BCl₃.

19. The method as claimed in claim 4, wherein MC is BCl₃.

20. The method as claimed in claim 5, wherein M is Ga, Al or Fe.

21. The method as claimed in claim 5, wherein m is 2, 3 or 4.

22. The method as claimed in claim 6, wherein the metal salt is selected from the group consisting of FeCl₃, FeCl₂, AlCl₃, GaCl₃ and InCl₃.

23. The method as claimed in claim 7, wherein the amount of the metal salt MS is from about 0.01 mol % to about 5 mol %.

24. The method as claimed in claim 7, wherein the amount of the metal salt MS is from about 0.1 mol % to about 2 mol %.

25. The method as claimed in claim 8, wherein the reaction temperature is from about 0° C. to about 150° C.

26. The method as claimed in claim 8, wherein the reaction temperature is from about 20° C. to about 130° C.

27. The method as claimed in claim 8, wherein the reaction temperature is from about 30° C. to about 110° C.

28. The method as claim in claim 9, wherein the Cl/Si—O mole ratio is from about 2 to about 3.

29. The method as claimed in claim 9, wherein the Cl/Si—O mole ratio is from about 2 to about 2.5.

30. The method as claimed in claim 9, wherein the Cl/Si—O mole ratio is about 2.

31. The method as claimed in claim 10, wherein the amount of the MC is from about 50 mol % to about 800 mol % relative to the number of moles of Si—O.

32. The method as claimed in claim 10, wherein the amount of the MC is from about 50 mol % to about 300 mol %.

33. The method as claimed in claim 10, wherein the amount of the MC is from about 50 mol % to about 200 mol %.
